(19) United States
(12) Patent Application Publication
(10) Pub. No.: US 2014/0132866 A1
(43) Pub. Date: May 15, 2014

(54) LIQUID CRYSTAL PANEL AND MANUFACTURING METHOD THEREOF AND MANUFACTURING METHOD OF COLOR FILTER SUBSTRATE

(71) Applicant: SHENZHEN CHINA STAR OPTOELECTRONICS TECHNOLOGY CO., LTD, Shenzhen, Guangdong (CN)

(72) Inventor: Haijian Zhang, Shenzhen (CN)

(21) Appl. No.: 13/811,414

(22) PCT Filed: Nov. 20, 2012
(86) PCT No.: PCT/CN2012/084893

§ 371 Date: Jan. 22, 2013

(30) Foreign Application Priority Data
Nov. 13, 2012 (CN) 201210453734.6

(51) Int. Cl. G02F 1/1335

(52) U.S. Cl. CPC G02F 1/133514
USPC 349/42; 438/27; 264/400

(57) ABSTRACT

The present disclosure provides a liquid crystal panel, a manufacturing method thereof and a manufacturing method of a CF substrate. The manufacturing method of the liquid crystal panel includes: manufacturing a CF substrate and a TFT substrate with voltage-applying terminals, forming through holes at positions of the CF substrate corresponding to the voltage-applying terminals of the TFT substrate, and bonding the TFT substrate and the CF substrate. With the through holes formed in the CF substrate and corresponding to the voltage-applying terminals of the TFT substrate, the voltage-applying terminals can be revealed without cutting the CF substrate after the CF substrate and the TFT substrate are bonded together, which avoids reprocess due to cutting abnormality and further improves the yield rate of the liquid crystal panel.

### BACKGROUND

1. Technical Field

The present disclosure relates to technologies of liquid crystal panels and, particularly, to a liquid crystal panel and a manufacturing method thereof and a manufacturing method of a color filter.

2. Description of Related Art

Generally, a manufacturing method of a liquid crystal panel includes the following steps.

1. Manufacturing a TFT (thin film transistor) substrate and a CF (color filter) substrate each of which defines a displaying area and a non-displaying area. Voltage-applying terminals are arranged on the non-displaying area of the TFT substrate. A color filter layer is configured on the displaying area of the CF substrate.

2. Coating a sealant on the non-displaying area of the CF substrate, dropping liquid crystals onto the displaying area of the TFT substrate, and bonding the TFT substrate and the CF substrate to form the liquid crystal panel.

3. Cutting a portion of the CF substrate which covers the voltage-applying terminals of the TFT substrate by a veneer-cutting machine to reveal the voltage-applying terminals on the non-displaying area.

4. Applying voltage to the voltage-applying terminals and irradiating the liquid crystal panel with ultraviolet light to realize the alignment of the liquid crystal panel.

In the above step 3, the cutting ability of the veneer-cutting machine is affected by various factors easily. Sometimes the sealant may appear on the non-displaying area of the CF substrate, causing the non-displaying areas of the TFT substrate and the CF substrate to be bonded together. At this state, the portion of the CF substrate which covers the voltage-applying terminals cannot be completely removed or even cannot removed after cut by the veneer-cutting machine, which may affect the alignment of the liquid crystal panel and even causes the abandoning of the liquid crystal panel. Generally, operators may remove the remained portion of the CF substrate manually after the CF substrate is cut by the veneer-cutting machine or have the CF substrate re-cut. However, removing the remained portion of the CF substrate manually requires the manufacturing machine to be turned off and re-cutting the CF substrate requires the cut liquid crystal panel to be transferred into the veneer-cutting machine again, which reduces the yield rate of the liquid crystal panel.

### SUMMARY

The present disclosure provides a liquid crystal panel and manufacturing method thereof and a manufacturing method of a CF substrate, which improve the yield rate of the liquid crystal panel.

The manufacturing method of a liquid crystal panel provided in the present disclosure includes:
manufacturing a CF substrate and a TFT substrate with voltage-applying terminals;
forming through holes at positions of the CF substrate corresponding to the voltage-applying terminals of the TFT substrate; and
bonding the TFT substrate and the CF substrate.

Preferably, the manufacturing method further includes the following step before the step of forming through holes at positions of the CF substrate corresponding to the voltage-applying terminals of the TFT substrate:
determining the positions of the through holes of the CF substrate according to the positions of the voltage-applying terminals of the TFT substrate.

Preferably, the step of forming through holes at positions of the CF substrate corresponding to the voltage-applying terminals of the TFT substrate is:
forming through holes at positions of the CF substrate corresponding to the voltage-applying terminals of the TFT substrate by using a laser punching device.

Preferably, the laser punching device is a CO₂ laser punching device.

Preferably, the manufacturing method further includes the following step after the step of bonding the TFT substrate and the CF substrate:
applying voltage onto the voltage-applying terminals by passing through the through holes.

Preferably, the through holes respectively correspond to the voltage-applying terminals.

Preferably, each of the through holes corresponds to at least two of the voltage-applying terminals.

The liquid crystal panel provided in the present disclosure includes:
a TFT substrate configured with voltage-applying terminals;
a CF substrate being bonded to the TFT substrate and forming a plurality of through holes corresponding to the voltage-applying terminals.

Preferably, the through holes respectively correspond to the voltage-applying terminals.

Preferably, each of the through holes corresponds to at least two of the voltage-applying terminals.

The present disclosure further provides another manufacturing method of a CF substrate, including:
defining a displaying area and a non-displaying area of the CF substrate; and
forming through holes in the non-displaying area of the CF substrate which correspond to positions of voltage-applying terminals of a TFT substrate.

Preferably, the manufacturing method further includes the following step before the step of forming through holes in the non-displaying area of the CF substrate which correspond to positions of voltage-applying terminals of a TFT substrate:
determining positions of the through holes of the non-displaying area of the CF substrate according to positions of the voltage-applying terminals of the TFT substrate.

Preferably, the step of forming through holes in the non-displaying area of the CF substrate which correspond to positions of voltage-applying terminals of a TFT substrate is:
forming through holes in the non-displaying area of the CF substrate which correspond to positions of voltage-applying terminals of a TFT substrate by using a laser punching device.

Preferably, the laser punching device is a CO₂ laser punching device.

Preferably, the through holes respectively correspond to the voltage-applying terminals, or each of the through holes corresponds to at least two of the voltage-applying terminals.

In the manufacturing method of the present disclosure, through holes are formed in the CF substrate to correspond to the voltage-applying terminals on the TFT substrate. After the CF substrate and the TFT substrate are bonded together, the through holes reveal the voltage-applying terminals, thus, the voltage-applying terminals can be revealed without cutting the CF substrate, which avoids reprocess due to cutting abnormality and further improves the yield rate of the liquid crystal panel.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a flow chart of a manufacturing method of a liquid crystal panel in accordance with a first embodiment of the present disclosure;

FIG. 2 is a flow chart of a manufacturing method of a liquid crystal panel in accordance with a second embodiment of the present disclosure;

FIG. 3 is a flow chart of a manufacturing method of a CF substrate in accordance with a first embodiment of the present disclosure;

FIG. 4 is a schematic view of a liquid crystal panel in accordance with a first embodiment of the present disclosure;

FIG. 5 is an exploded view of the liquid crystal panel of FIG. 4;

FIG. 6 is a schematic view of a liquid crystal panel in accordance with a second embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

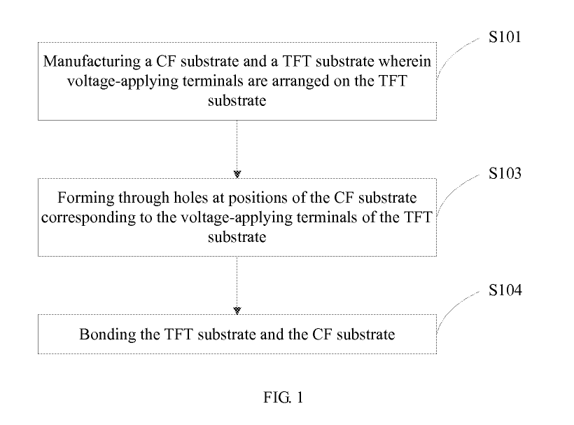

Referring to FIG. 1, which is a flow chart of a manufacturing method of a liquid crystal panel in accordance with a first embodiment of the present disclosure. The manufacturing method includes the following steps:

Step S101, manufacturing a CF substrate and a TFT substrate wherein voltage-applying terminals are arranged on the TFT substrate.

In the Step S101, the CF substrate and the TFT substrate define a displaying area and a non-displaying area respectively, and the voltage-applying terminals are configured at the non-displaying area of the TFT substrate.

Step S103, forming through holes at positions of the CF substrate corresponding to the voltage-applying terminals of the TFT substrate.

In the step S103, a punching device can be used for forming the through holes in the CF substrate. The punching device can be any suitable punching device, which is preferably a laser punching device in the embodiment, especially a CO₂ laser punching device. Since the CF substrate is made of glass which has good absorbency to light having a wavelength more than 5 um. Therefore, a sealed CO₂ laser punching device having a wavelength of 10.6 um and a power ranging between 100 W and 500 W can be used for forming through holes in the CF substrate. The CF substrate than is partially heated up after absorbing laser, which allows the laser punching device to punch holes along the scanning direction of laser. After the laser punching device punches holes, an edge of the CF substrate is smooth and there are no lateral lines and fragments, which prevents the CF substrate from being damaged during the holes punching process and reduces the possibility of breaking the CF substrate. In order to improve the yield rate of the liquid crystal panel, a number of CO₂ laser punching devices can be used for punching a number of holes at the corresponding parts of the CF substrate.

Step S104, bonding the TFT substrate and the CF substrate.

In the step S104, liquid crystals are at first dropped onto the displaying area of the TFT substrate or the CF substrate and a sealant is correspondingly coated on the non-displaying area of the CF substrate or the TFT substrate, and then the CF substrate and the TFT substrate are vacuum bonded together.

Next, voltage is applied to the voltage-applying terminals of the TFT substrate. Since the voltage-applying terminals are revealed in the through holes formed in the CF substrate, therefore, a probe of a voltage-applying device can contact the voltage-applying terminals directly by passing through the through holes to apply voltage onto the voltage-applying terminals. In the manufacturing method of the liquid crystal panel of the embodiment, there is no need to cut the portion of the CF substrate which covers the voltage-applying terminals after the CF substrate and the TFT substrate are bonded together. Thus, the present disclosure can prevent the yield rate of the liquid crystal panel from being reduced due to the abnormal cutting of a veneer-cutting machine and prevent the incomplete removal of the corresponding portion of the CF substrate from affecting the voltage-applying operation and further causing abnormal alignment of the liquid crystal panel. Therefore, the manufacturing method of the present disclosure improves the yield rate of the liquid crystal panel.

In the above embodiment, each through hole can correspond to at least two of the voltage-applying terminals, for example, each through hole corresponds to four of the voltage-applying terminals. The non-displaying area of the CF substrate may even form only one long and narrow through hole to reveal all the voltage-applying terminals on a corresponding side of the TFT substrate. Preferably, in the embodiment, the through holes formed in the CF substrate respectively correspond to the voltage-applying terminals on the TFT substrate. That is, each through hole corresponds to one through hole. In this way, when the voltage-applying device applies voltage, each probe passes through a through hole to apply voltage onto the corresponding voltage-applying terminal, which improves the precision of the voltage-applying operation.

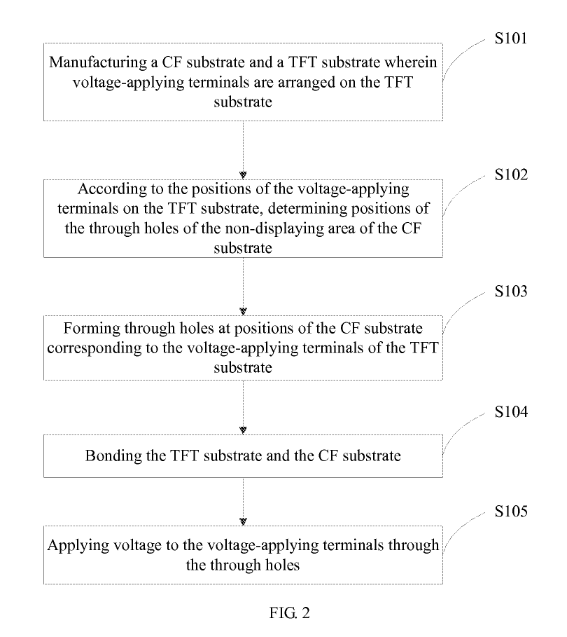

Furthermore, in order to improve the precision of the positions of the punching holes, referring to FIG. 2, the present disclosure further provides a manufacturing method of the liquid crystal panel in accordance with a second embodiment. The manufacturing method includes the following steps:

Step S101, manufacturing a CF substrate and a TFT substrate wherein voltage-applying terminals are arranged on the TFT substrate.

In the step S101, both the CF substrate and the TFT substrate define a displaying area and a non-displaying area respectively, and the voltage-applying terminals are configured at the non-displaying area of the TFT substrate.

Step S102, according to the positions of the voltage-applying terminals on the TFT substrate, determining positions of the through holes of the non-displaying area of the CF substrate.

In the step S102, the positions of the voltage-applying terminals of the TFT substrate are at first determined and the positions of the through holes of the CF substrate are determined according to the positions of the voltage-applying terminals, which improves the precision of the positions of the through holes. The positions of the through holes on the CF substrate can be labeled to allow the through holes to be formed precisely in following procedures. In the embodiment, coordinates of the through holes of the CF substrate are preset in the CO₂ laser punching device to allow the CO₂ laser punching device to punch holes automatically according to the coordinates.

Step S103, forming through holes at positions of the CF substrate corresponding to the voltage-applying terminals of the TFT substrate.

In the step S103, a punching device is used for forming the through holes in the CF substrate. Since the positions of the through holes are pre-determined in the step S102, thus, the through holes can be precisely formed according to the labeled positions or to the input coordinates. In the embodiment, the CO₂ laser punching device automatically forms the through holes in the CF substrate according to the preset coordinates.

Step S104, bonding the TFT substrate and the CF substrate together.

In the step S104, liquid crystals are at first dropped onto the displaying area of the TFT substrate or the CF substrate and a sealant is correspondingly coated on the non-displaying area of the CF substrate or the TFT substrate, and then the CF substrate and the TFT substrate are vacuum bonded together.

Step S105, applying voltage to the voltage-applying terminals through the through holes.

In the step S105, since the voltage-applying terminals are revealed in the through holes formed in the CF substrate, therefore, a probe of a voltage-applying device can contact the voltage-applying terminals directly by passing through the through holes to apply voltage onto the voltage-applying terminals.

By pre-determining the positions of the through holes of the CF substrate, the through holes can be precisely formed to precisely reveal the voltage-applying terminals after the CF substrate and the TFT substrate are bonded together, which avoids reprocess of the liquid crystal panel caused by the misalignment of the through holes and thus improves the yield rate of the liquid crystal panel.

Referring to FIG. 3, a manufacturing method of the CF substrate in accordance with an embodiment of the present disclosure is provided. The manufacturing method includes the following steps:

Step S201, defining a displaying area and a non-displaying area of the CF substrate.

Step S202, according to positions of voltage-applying terminals of a TFT substrate which is bonded to the CF substrate, determining positions of the through holes of the CF substrate.

In the step S202, the positions of the voltage-applying terminals of the TFT substrate are at first determined and the positions of the through holes of the CF substrate are determined according to the positions of the voltage-applying terminals, which improves the precision of the positions of the through holes. The positions of the through holes of the CF substrate can be labeled to allow a punching device to precisely form the through holes in following procedures. Preferably, in the embodiment, the punching device is a laser punching device, especially a CO₂ laser punching device. Since the CF substrate is made of glass which has good absorbency to light having a wavelength more than 5 um. Therefore, a sealed CO₂ laser punching device having a wavelength of 10.6 um and a power ranging between 100 W and 500 W can be used for forming through holes in the CF substrate. The CF substrate is partially rapidly heated up after absorbing laser, which allows the laser punching device to punch holes along the scanning direction of laser. By presetting the coordinates of the through holes on the CF substrate in the CO₂ laser punching device, the CO₂ laser punching device is capable of automatically punching holes according to the coordinates.

Step S203, forming the through holes at the determined positions.

In the step S203, the punching device is used for forming the through holes in the CF substrate. Since the positions of the through holes are pre-determined in the step S202, thus, the through holes can be precisely formed according to the labeled positions or to the input coordinates. In the embodiment, the CO₂ laser punching device automatically forms the through holes in the CF substrate according to the preset coordinates. After the laser punching device punches holes, an edge of the CF substrate is smooth and there are no lateral lines and fragments, which prevents the CF substrate from being damaged during the holes punching process and reduces the possibility of breaking the CF substrate. In order to improve the yield rate of the liquid crystal panel, a number of CO₂ laser punching devices can be used for respectively punching a number of holes at the corresponding parts of the CF substrate.

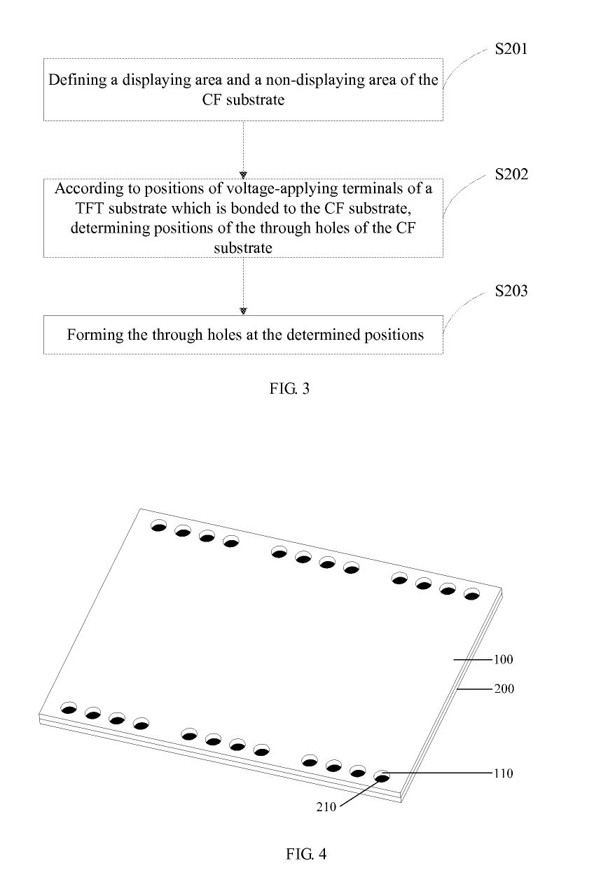

Referring to FIGS. 4 and 5, a liquid crystal panel in accordance with a first embodiment of the present disclosure is provided. The liquid crystal panel includes a CF substrate 100 and a TFT substrate 200 bonded to the CF substrate 100. The CF substrate 100 and the TFT substrate 200 define a displaying area and a non-displaying area respectively. A number of through holes 110 are formed in the non-displaying area of the CF substrate 100. A number of voltage-applying terminals 210 respectively corresponding to the through holes 110 are arranged at the non-displaying area of the TFT substrate 200. In the embodiment, the through holes 110 are formed in the CF substrate 100 to reveal the voltage-applying terminals 210 on the TFT substrate 200, thus, a probe of a voltage-applying device is capable of contacting the voltage-applying terminals through the through holes 110 to apply voltage onto the voltage-applying terminals and further to realize the alignment of the liquid crystal panel. This improves the yield rate and quality of the liquid crystal panel.

Furthermore, the through holes 110 in the CF substrate 100 respectively correspond to the voltage-applying terminals 210 on the TFT substrate. That is, each voltage-applying terminal 210 correspond to one through hole 110. Therefore, when the voltage-applying device is applying voltage, each probe of the voltage-applying device is capable of passing through one through hole 110 to apply voltage onto the corresponding voltage-applying terminal 210, which improves the precision of the voltage-applying operation.

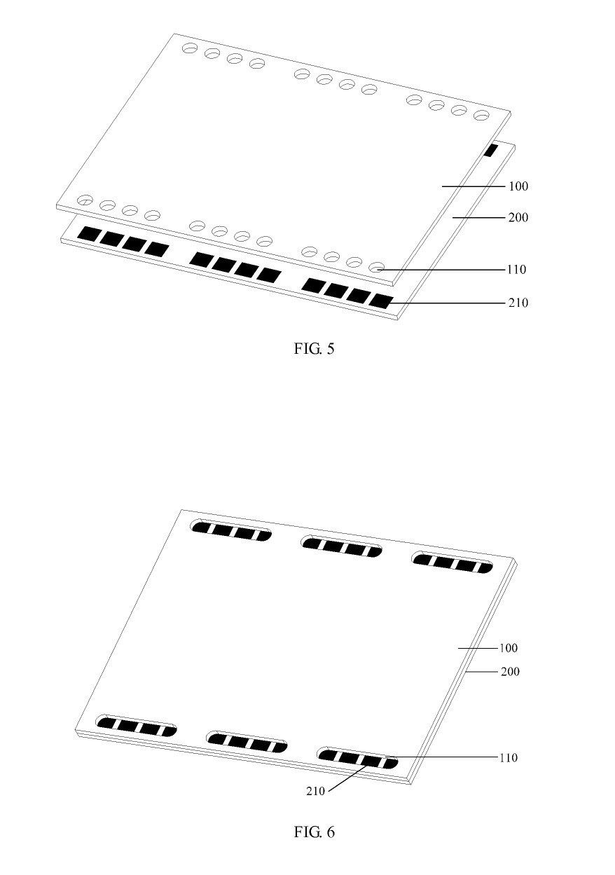

Referring to FIG. 6, a liquid crystal panel in accordance with a second embodiment is provided. The through holes 110 in the CF substrate 100 of the liquid crystal panel are respectively a long and narrow hole which corresponds to four of the voltage-applying terminals 210 of the TFT substrate 200. When the voltage-applying device is applying voltage, the probes are capable of passing through one of the through holes 110 to apply voltage onto four of the voltage-applying terminals 210. It is noted that each through hole 110 can correspond to two of the voltage-applying terminals 210. The non-displaying area on one side of the CF substrate may even form only one long and narrow hole to reveal all the voltage-applying terminals of a corresponding side of the TFT substrate. In the embodiment, each through hole 110 corresponds to a number of voltage-applying terminals 210, which improves the efficiency of the laser punching device.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A manufacturing method of a liquid crystal panel, comprising:
manufacturing a CF substrate and a TFT substrate with voltage-applying terminals;
forming through holes at positions of the CF substrate corresponding to the voltage-applying terminals of the TFT substrate; and
bonding the TFT substrate and the CF substrate.

2. The manufacturing method as claimed in claim 1, further comprising the following step before the step of forming through holes at positions of the CF substrate corresponding to the voltage-applying terminals of the TFT substrate:
determining the positions of the through holes of the CF substrate according to the positions of the voltage-applying terminals of the TFT substrate.

3. The manufacturing method as claimed in claim 1, wherein the step of forming through holes at positions of the CF substrate corresponding to the voltage-applying terminals of the TFT substrate is:
forming through holes at positions of the CF substrate corresponding to the voltage-applying terminals of the TFT substrate by using a laser punching device.

4. The manufacturing method as claimed in claim 3, wherein the laser punching device is a CO₂ laser punching device.

5. The manufacturing method as claimed in claim 1, further comprising the following step after the step of bonding the TFT substrate and the CF substrate:
applying voltage onto the voltage-applying terminals by passing through the through holes.

6. The manufacturing method as claimed in claim 1, wherein the through holes respectively correspond to the voltage-applying terminals.

7. The manufacturing method as claimed in claim 1, wherein each of the through holes corresponds to at least two of the voltage-applying terminals.

8. A liquid crystal panel, comprising:
a TFT substrate configured with voltage-applying terminals;
a CF substrate being bonded to the TFT substrate and forming a plurality of through holes corresponding to the voltage-applying terminals.

9. The liquid crystal panel as claimed in claim 8, wherein the through holes respectively correspond to the voltage-applying terminals.

10. The liquid crystal panel as claimed in claim 8, wherein each of the through holes corresponds to at least two of the voltage-applying terminals.

11. A manufacturing method of a CF substrate, comprising:
defining a displaying area and a non-displaying area of the CF substrate; and
forming through holes in the non-displaying area of the CF substrate which correspond to positions of voltage-applying terminals of a TFT substrate.

12. The manufacturing method as claimed in claim 11, further comprising the following step before the step of forming through holes in the non-displaying area of the CF substrate which correspond to positions of voltage-applying terminals of a TFT substrate:
determining positions of the through holes of the non-displaying area of the CF substrate according to positions of the voltage-applying terminals of the TFT substrate.

13. The manufacturing method as claimed in claim 11, wherein the step of forming through holes in the non-displaying area of the CF substrate which correspond to positions of voltage-applying terminals of a TFT substrate is:
forming through holes in the non-displaying area of the CF substrate which correspond to positions of voltage-applying terminals of a TFT substrate by using a laser punching device.

14. The manufacturing method as claimed in claim 13, wherein the laser punching device is a CO₂ laser punching device.

15. The manufacturing method as claimed in claim 11, wherein the through holes respectively correspond to the voltage-applying terminals, or each of the through holes corresponds to at least two of the voltage-applying terminals.
